(19) United States
(12) Patent Application Publication
(10) Pub. No.: US 2025/0004857 A1
(43) Pub. Date: Jan. 2, 2025

(54) SYSTEMS AND METHODS FOR INTEGRATING ON-PREMISES SYSTEMS AND CLOUD-BASED SYSTEMS

(71) Applicant: Genesys Cloud Services, Inc., Menlo Park, CA (US)

(72) Inventors: Ravikumar Gopal, Chennai (IN); Anantha Asokan, Chennai (IN)

(21) Appl. No.: 18/345,612

(22) Filed: Jun. 30, 2023

(51) Int. Cl. G06F 9/50

(52) U.S. Cl. CPC G06F 9/5077; G06F 9/5038; G06F 9/5072

(57) ABSTRACT

A method of integrating an on-premises contact center with a cloud-based contact center according to an embodiment includes communicating resource data stored by the on-premises contact center to the cloud-based contact center, and synchronizing the resource data between the on-premises contact center and the cloud-based contact center to maintain consistency between the resource data stored by the on-premises contact center and the resource data stored by the cloud-based contact center.

### BACKGROUND

Call centers and other contact centers are used by many organizations to provide technical and other support to their end users. The end user may interact with human and/or virtual agents of the contact center by establishing electronic communications via one or more communication technologies including, for example, telephone, email, web chat, Short Message Service (SMS), dedicated software application(s), and/or other technologies. Contact centers may be employed in local computing environments (e.g., customer environments) or remote to such environments (e.g., cloud-based).

### SUMMARY

One embodiment is directed to a unique system, components, and methods for integrating an on-premises contact center with a cloud-based contact center. Other embodiments are directed to apparatuses, systems, devices, hardware, methods, and combinations thereof for integrating on-premises contact centers with cloud-based contact centers.

According to an embodiment, a connector for integrating an on-premises contact center with a cloud-based contact center may include at least one processor and at least one memory comprising a plurality of instructions stored therein that, in response to execution by the at least one processor, causes the connector to communicate resource data stored by the on-premises contact center to the cloud-based contact center, and to synchronize the resource data between the on-premises contact center and the cloud-based contact center to maintain consistency between the resource data stored by the on-premises contact center and the resource data stored by the cloud-based contact center, and to synchronize the resource data between the on-premises contact center and the cloud-based contact center includes to create at least one first object identifier associated with one or more objects of the resource data stored by the on-premises contact center, to create at least one second object identifier associated with one or more objects of the resource data stored by the cloud-based contact center, and to map the at least one first object identifier to the at least one second object identifier to establish a mapped correspondence between the one or more objects of the resource data stored by the on-premises contact center and the one or more objects of the resource data stored by the cloud-based contact center.

In some embodiments, to synchronize the resource data between the on-premises contact center and the cloud-based contact center may include to detect changes to the one or more objects of the resource data stored by the on-premises contact center and to update the one or more objects of the resource data stored by the cloud-based contact center such that the one or more objects of the resource data stored by the cloud-based contact center reflect the changes to the one or more objects of the resource data stored by the on-premises contact center.

In some embodiments, to update the one or more objects of the resource data stored by the cloud-based contact center may include to update the one or more objects of the resource data stored by the cloud-based contact center based on the mapped correspondence.

In some embodiments, to synchronize the resource data between the on-premises contact center and the cloud-based contact center may include to query one object identifier associated with the one or more objects of the resource data stored by the cloud-based contact center and to determine the one object identifier based on another object identifier associated with the one or more objects of the resource data stored by the on-premises contact center that corresponds to the one object identifier according to the mapped correspondence.

In some embodiments, to synchronize the resource data between the on-premises contact center and the cloud-based contact center may include to maintain at least one cache to store the mapped correspondence between the one object identifier and the another object identifier, to detect changes to the one or more objects of the resource data stored by the on-premises contact center, to update the one or more objects of the resource data stored by the cloud-based contact center such that the one or more objects of the resource data stored by the cloud-based contact center reflect the changes to the one or more objects of the resource data stored by the on-premises contact center, and to store the updates to the one or more objects of the resource data stored by the cloud-based contact center in the at least one cache.

In some embodiments, to communicate resource data stored by the on-premises contact center to the cloud-based contact center may include to transmit resource data indicative of a voice interaction to be routed to a contact center agent to the cloud-based contact center, to send agent availability data associated with the transmitted resource data to the cloud-based contact center, and to communicate routing status data associated with the transmitted resource data to the cloud-based contact center.

In some embodiments, to synchronize the resource data between the on-premises contact center and the cloud-based contact center may include to detect changes to the transmitted resource data, the agent availability data, and/or the routing status data and to update the resource data transmitted to the cloud-based contact center, the agent availability data, and/or the routing status data to reflect the changes.

In some embodiments, to communicate resource data stored by the on-premises contact center to the cloud-based contact center may include to transmit resource data indicative of a voice interaction to be routed to a contact center agent to the cloud-based contact center, and to synchronize the resource data between the on-premises contact center and the cloud-based contact center may include to to detect changes to the transmitted resource data and to update the resource data transmitted to the cloud-based contact center to reflect the changes.

In some embodiments, the resource data transmitted to the cloud-based contact center may include at least one of the following: event data corresponding to a monitored voice interaction, event data corresponding to one or more distinguished name (DN) extensions, and event data corresponding to one more distinguished name (DN) virtual queues.

In some embodiments, to communicate resource data stored by the on-premises contact center to the cloud-based contact center may include to send recording data indicative of a recording of the voice interaction to the cloud-based contact center, and to synchronize the resource data between the on-premises contact center and the cloud-based contact center may include to detect changes in the recording data and to update the recording data sent to the cloud-based contact center to reflect the changes.

In some embodiments, the connector may be implemented in an environment established by the on-premises contact center.

According to another embodiment, a method of integrating an on-premises contact center with a cloud-based contact center may include communicating resource data stored by the on-premises contact center to the cloud-based contact center and synchronizing the resource data between the on-premises contact center and the cloud-based contact center to maintain consistency between the resource data stored by the on-premises contact center and the resource data stored by the cloud-based contact center, and synchronizing the resource data between the on-premises contact center and the cloud-based contact center includes creating at least one first object identifier associated with one or more objects of the resource data stored by the on-premises contact center, creating at least one second object identifier associated with one or more objects of the resource data stored by the cloud-based contact center, and mapping the at least one first object identifier to the at least one second object identifier to establish a mapped correspondence between the one or more objects of the resource data stored by the on-premises contact center and the one or more objects of the resource data stored by the cloud-based contact center.

In some embodiments, synchronizing the resource data between the on-premises contact center and the cloud-based contact center may include detecting changes to the one or more objects of the resource data stored by the on-premises contact center and updating the one or more objects of the resource data stored by the cloud-based contact center such that the one or more objects of the resource data stored by the cloud-based contact center reflect the changes to the one or more objects of the resource data stored by the on-premises contact center, and updating the one or more objects of the resource data stored by the cloud-based contact center may include updating the one or more objects of the resource data stored by the cloud-based contact center based on the mapped correspondence.

In some embodiments, synchronizing the resource data between the on-premises contact center and the cloud-based contact center may include querying one object identifier associated with the one or more objects of the resource data stored by the cloud-based contact center and determining the one object identifier based on another object identifier associated with the one or more objects of the resource data stored by the on-premises contact center that corresponds to the one object identifier according to the mapped correspondence.

In some embodiments, synchronizing the resource data between the on-premises contact center and the cloud-based contact center may include maintaining at least one cache to store the mapped correspondence between the one object identifier and the another object identifier, detecting changes to the one or more objects of the resource data stored by the on-premises contact center, updating the one or more objects of the resource data stored by the cloud-based contact center such that the one or more objects of the resource data stored by the cloud-based contact center reflect the changes to the one or more objects of the resource data stored by the on-premises contact center, and storing the updates to the one or more objects of the resource data stored by the cloud-based contact center in the at least one cache.

In some embodiments, communicating resource data stored by the on-premises contact center to the cloud-based contact center may include transmitting resource data indicative of a voice interaction to be routed to a contact center agent to the cloud-based contact center, sending agent availability data associated with the transmitted resource data to the cloud-based contact center, and communicating routing status data associated with the transmitted resource data to the cloud-based contact center.

In some embodiments, synchronizing the resource data between the on-premises contact center and the cloud-based contact center may include detecting changes to the transmitted resource data, the agent availability data, and/or the routing status data and updating the resource data transmitted to the cloud-based contact center, the agent availability data, and/or the routing status data to reflect the changes.

In some embodiments, communicating resource data stored by the on-premises contact center to the cloud-based contact center may include transmitting resource data indicative of a voice interaction to be routed to a contact center agent to the cloud-based contact center and sending recording data indicative of a recording of the voice interaction to the cloud-based contact center, and synchronizing the resource data between the on-premises contact center and the cloud-based contact center may include detecting changes to the transmitted resource data, detecting changes in the recording data, updating the resource data transmitted to the cloud-based contact center to reflect the changes in the transmitted resource data, and updating the recording data sent to the cloud-based contact center to reflect the changes in the recording data.

According to yet another embodiment, one or more non-transitory machine readable storage media may include a plurality of instructions stored thereon that, in response to execution by a connector, causes the connector to communicate resource data stored by an on-premises contact center to a cloud-based contact center and synchronize the resource data between the on-premises contact center and the cloud-based contact center to maintain consistency between the resource data stored by the on-premises contact center and the resource data stored by the cloud-based contact center, and to synchronize the resource data between the on-premises contact center and the cloud-based contact center includes to create at least one first object identifier associated with one or more objects of the resource data stored by the on-premises contact center, to create at least one second object identifier associated with one or more objects of the resource data stored by the cloud-based contact center, and to map the at least one first object identifier to the at least one second object identifier to establish a mapped correspondence between the one or more objects of the resource data stored by the on-premises contact center and the one or more objects of the resource data stored by the cloud-based contact center.

In some embodiments, to synchronize the resource data between the on-premises contact center and the cloud-based contact center may include to detect changes to the one or more objects of the resource data stored by the on-premises contact center and to update the one or more objects of the resource data stored by the cloud-based contact center such that the one or more objects of the resource data stored by the cloud-based contact center reflect the changes to the one or more objects of the resource data stored by the on-premises contact center.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of a computing device;

FIG. 2 is a simplified block diagram of at least one embodiment of a contact center system and/or communications infrastructure;

FIG. 3 is a simplified block diagram of at least one embodiment of a cloud-based system;

FIG. 4 is a simplified diagram of at least one embodiment of an on-premises contact center system integrated with a cloud-based contact center system via a connector implemented in an environment established by the on-premises contact center system;

FIG. 5 is a simplified diagram similar to FIG. 4 illustrating various components of the on-premises contact center system, the connector, and the cloud-based contact center system;

FIG. 6 is a simplified diagram illustrating various components of the on-premises contact center system and the connector and communicative couplings therebetween;

FIG. 7 is a simplified flow diagram of at least one embodiment of a method of integrating the on-premises contact center system with the cloud-based contact center system via the connector;

FIG. 8 is a simplified flow diagram of a portion of a method of synchronizing data between the on-premises contact center system and the cloud-based contact center system via a configuration sync module of the connector;

FIG. 9 is a simplified flow diagram of another portion of the method of FIG. 8;

FIG. 10 is a simplified flow diagram of a method of synchronizing data between the on-premises contact center system and the cloud-based contact center system via an agent sync module of the connector;

FIG. 11 is a simplified flow diagram of a method of synchronizing data between the on-premises contact center system and the cloud-based contact center system via a conversation provider module of the connector, and

FIG. 12 is a simplified flow diagram of a method of synchronizing data between the on-premises contact center system and the cloud-based contact center system via a recording provider module of the connector.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

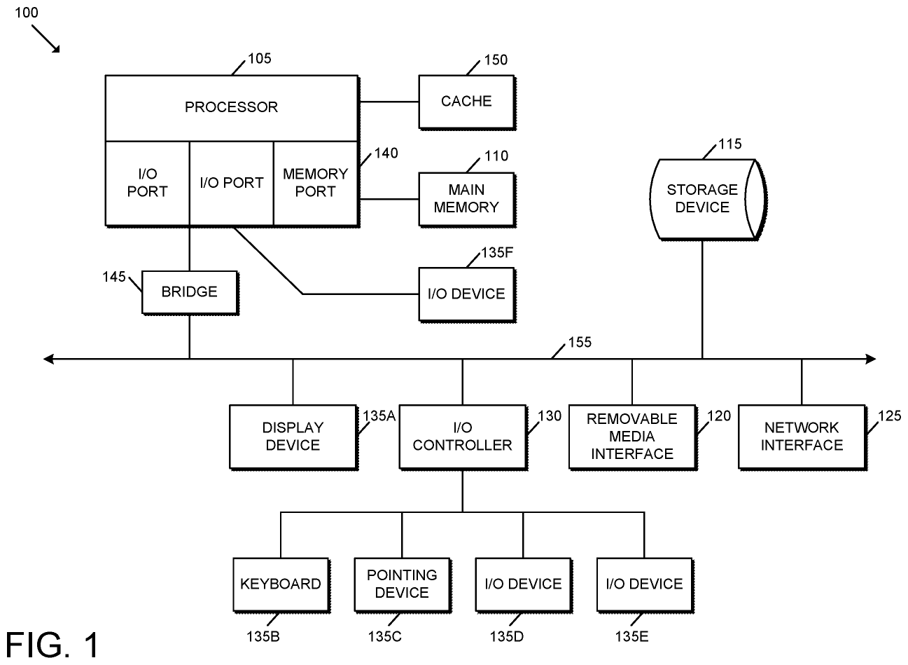

Referring now to FIG. 1, a simplified block diagram of at least one embodiment of a computing device 100 is shown. The illustrative computing device 100 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the servers may be a process or thread running on one or more processors of one or more computing devices 100, which may be executing computer program instructions and interacting with other system modules in order to perform the various functionalities described herein.

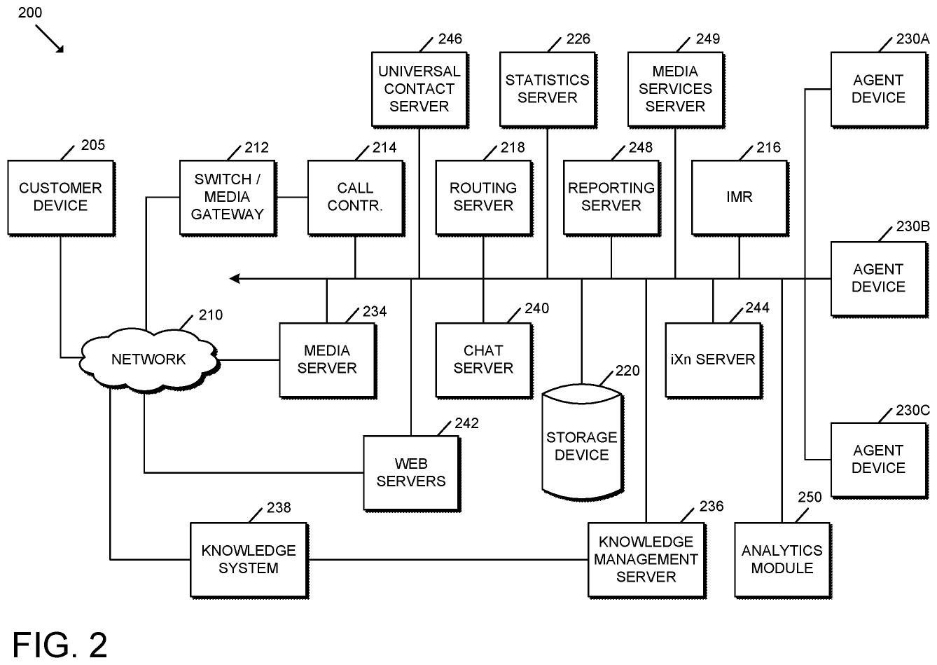

Unless otherwise specifically limited, the functionality described in relation to a plurality of computing devices may be integrated into a single computing device, or the various functionalities described in relation to a single computing device may be distributed across several computing devices. Further, in relation to the computing systems described herein-such as the contact center system 200 of FIG. 2—the various servers and computing devices thereof may be located on local computing devices 100 (e.g., on-site or on-premises at the same physical location as the agents of the contact center), remote computing devices 100 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

As shown in the illustrated example, the computing device 100 may include a central processing unit (CPU) or processor 105 and a main memory 110. The computing device 100 may also include a storage device 115, a removable media interface 120, a network interface 125, an input/output (I/O) controller 130, and one or more input/output (I/O) devices 135. For example, as depicted, the I/O devices 135 may include a display device 135A, a keyboard 135B, and/or a pointing device 135C. The computing device 100 may further include additional elements, such as a memory port 140, a bridge 145, one or more I/O ports, one or more additional input/output (I/O) devices 135D, 135E, 135F, and/or a cache memory 150 in communication with the processor 105.

The processor 105 may be any logic circuitry that responds to and processes instructions fetched from the main memory 110. For example, the processor 105 may be implemented by an integrated circuit (e.g., a microprocessor, microcontroller, or graphics processing unit), or in a field-programmable gate array (FPGA) or application-specific integrated circuit (ASIC). The processor 105 may include, or otherwise be embodied as, a high-power processor, an accelerator co-processor, or a storage controller. The main memory 110 may include, or otherwise be embodied as, any type of volatile (e.g., dynamic random access memory (DRAM), etc.) or non-volatile memory capable of storing data therein.

As depicted, the processor 105 may communicate directly with the cache memory 150 via a secondary bus or backside bus. It should be appreciated that the cache memory 150 typically has a faster response time than the main memory 110. The main memory 110 may be one or more memory chips capable of storing data and allowing stored data to be directly accessed by the processor 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices may include, for example, a keyboard 135B and a pointing device 135C (e.g., a mouse or optical pen). Output devices may include, for example, video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

The computing device 100 may be any workstation, desktop computer, laptop or notebook computer, server machine, virtualized machine, mobile or smart phone, portable telecommunication device, media playing device, gaming system, mobile computing device, or any other type of computing, telecommunications or media device, without limitation, capable of performing the operations and functionality described herein. Although described in the singular for clarity and brevity of the description, the computing device 100 may include a plurality of devices connected by a network or connected to other systems and resources via a network. As used herein, a network may be embodied as or include one or more computing devices, machines, clients, client nodes, client machines, client computers, client devices, endpoints, or endpoint nodes in communication with one or more other computing devices, machines, clients, client nodes, client machines, client computers, client devices, endpoints, or endpoint nodes. For example, the network may be embodied as or include a private or public switched telephone network (PSTN), wireless carrier network, local area network (LAN), private wide area network (WAN), public WAN such as the Internet, etc., with connections being established using appropriate communication protocols. More generally, it should be understood that, unless otherwise limited, the computing device 100 may communicate with other computing devices 100 via any type of network using any suitable communication protocol. Further, the network may be a virtual network environment where various network components are virtualized. For example, the various machines may be virtual machines implemented as a software-based computer running on a physical machine, or a “hypervisor” type of virtualization may be used where multiple virtual machines run on the same host physical machine. Other types of virtualization may be employed in other embodiments.

Referring now to FIG. 2, a simplified block diagram of at least one embodiment of a communications infrastructure and/or content center system, which may be used in conjunction with one or more of the embodiments described herein, is shown. The contact center system 200 may be embodied as any system capable of providing contact center services (e.g., call center services, chat center services, SMS center services, etc.) to an end user and otherwise performing the functions described herein. The illustrative contact center system 200 includes a customer device 205, a network 210, a switch/media gateway 212, a call controller 214, an interactive media response (IMR) server 216, a routing server 218, a storage device 220, a statistics server 226, agent devices 230A, 230B, 230C, a media server 234, a knowledge management server 236, a knowledge system 238, chat server 240, web servers 242, an interaction (iXn) server 244, a universal contact server 246, a reporting server 248, a media services server 249, and an analytics module 250. Although only one customer device 205, one network 210, one switch/media gateway 212, one call controller 214, one IMR server 216, one routing server 218, one storage device 220, one statistics server 226, one media server 234, one knowledge management server 236, one knowledge system 238, one chat server 240, one iXn server 244, one universal contact server 246, one reporting server 248, one media services server 249, and one analytics module 250 are shown in the illustrative embodiment of FIG. 2, the contact center system 200 may include multiple customer devices 205, networks 210, switch/media gateways 212, call controllers 214, IMR servers 216, routing servers 218, storage devices 220, statistics servers 226, media servers 234, knowledge management servers 236, knowledge systems 238, chat servers 240, iXn servers 244, universal contact servers 246, reporting servers 248, media services servers 249, and/or analytics modules 250 in other embodiments. Further, in some embodiments, one or more of the components described herein may be excluded from the system 200, one or more of the components described as being independent may form a portion of another component, and/or one or more of the components described as forming a portion of another component may be independent.

It should be understood that the term “contact center system” is used herein to refer to the system depicted in FIG. 2 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 200), the associated customer service provider (such as a particular customer service provider providing customer services through the contact center system 200), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VOIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 200 may be used by a customer service provider to provide various types of services to customers. For example, the contact center system 200 may be used to engage and manage interactions in which automated processes (or bots) or human agents communicate with customers. As should be understood, the contact center system 200 may be an in-house facility to a business or enterprise for performing the functions of sales and customer service relative to products and services available through the enterprise. In another embodiment, the contact center system 200 may be operated by a third-party service provider that contracts to provide services for another organization. Further, the contact center system 200 may be deployed on equipment dedicated to the enterprise or third-party service provider, and/or deployed in a remote computing environment such as, for example, a private or public cloud environment with infrastructure for supporting multiple contact centers for multiple enterprises. The contact center system 200 may include software applications or programs, which may be executed on premises or remotely or some combination thereof. It should further be appreciated that the various components of the contact center system 200 may be distributed across various geographic locations and not necessarily contained in a single location or computing environment.

It should further be understood that, unless otherwise specifically limited, any of the computing elements of the technologies described herein may be implemented in cloud-based or cloud computing environments, such as the cloud-based system 300. As used herein, “cloud computing”- or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

It should be understood that any of the computer-implemented components, modules, or servers described in relation to FIG. 2 may be implemented via one or more types of computing devices, such as, for example, the computing device 100 of FIG. 1. As will be seen, the contact center system 200 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 200 may initiate inbound communications (e.g., telephone calls, emails, chats, etc.) to the contact center system 200 via a customer device 205. While FIG. 2 shows one such customer device—i.e., customer device 205—it should be understood that any number of customer devices 205 may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center system 200, such as telephone calls, emails, chats, text messages, web-browsing sessions, and other multi-media transactions.

Inbound and outbound communications from and to the customer devices 205 may traverse the network 210, with the nature of the network typically depending on the type of customer device being used and the form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 212 may be coupled to the network 210 for receiving and transmitting telephone calls between customers and the contact center system 200. The switch/media gateway 212 may include a telephone or communication switch configured to function as a central switch for agent level routing within the center. The switch may be a hardware switching system or implemented via software. For example, the switch 212 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. Thus, in general, the switch/media gateway 212 establishes a voice connection between the customer and the agent by establishing a connection between the customer device 205 and agent device 230.

As further shown, the switch/media gateway 212 may be coupled to the call controller 214 which, for example, serves as an adapter or interface between the switch and the other routing, monitoring, and communication-handling components of the contact center system 200. The call controller 214 may be configured to process PSTN calls, VOIP calls, and/or other types of calls. For example, the call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

The interactive media response (IMR) server 216 may be configured to enable self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may instruct customers via the IMR script to “press 1” if they wish to retrieve their account balance. Through continued interaction with the IMR server 216, customers may receive service without needing to speak with an agent. The IMR server 216 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment (e.g. Genesys® Designer).

The routing server 218 may function to route incoming interactions. For example, once it is determined that an inbound communication should be handled by a human agent, functionality within the routing server 218 may select the most appropriate agent and route the communication thereto. This agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described herein, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230. This information is intended to enhance the service the agent is able to provide to the customer.

It should be appreciated that the contact center system 200 may include one or more mass storage devices—represented generally by the storage device 220—for storing data in one or more databases relevant to the functioning of the contact center. For example, the storage device 220 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database. Agent data maintained by the contact center system 200 may include, for example, agent availability and agent profiles, schedules, skills, handle time, and/or other relevant data. As another example, the storage device 220 may store interaction data in an interaction database. Interaction data may include, for example, data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center system 200 in ways that facilitate the functionality described herein. For example, the servers or modules of the contact center system 200 may query such databases to retrieve data stored therein or transmit data thereto for storage. The storage device 220, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 226 may be configured to record and aggregate data relating to the performance and operational aspects of the contact center system 200. Such information may be compiled by the statistics server 226 and made available to other servers and modules, such as the reporting server 248, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center system 200 may be communication devices configured to interact with the various components and modules of the contact center system 200 in ways that facilitate functionality described herein. An agent device 230, for example, may include a telephone adapted for regular telephone calls or VOIP calls. An agent device 230 may further include a computing device configured to communicate with the servers of the contact center system 200, perform data processing associated with operations, and interface with customers via voice, chat, email, and other multimedia communication mechanisms according to functionality described herein. Although FIG. 2 shows three such agent devices 230—i.e., agent devices 230A, 230B and 230C—it should be understood that any number of agent devices 230 may be present in a particular embodiment.

The multimedia/social media server 234 may be configured to facilitate media interactions (other than voice) with the customer devices 205 and/or the servers 242. Such media interactions may be related, for example, to email, voice mail, chat, video, text-messaging, web, social media, co-browsing, etc. The multi-media/social media server 234 may take the form of any IP router conventional in the art with specialized hardware and software for receiving, processing, and forwarding multi-media events and communications.

The knowledge management server 236 may be configured to facilitate interactions between customers and the knowledge system 238. In general, the knowledge system 238 may be a computer system capable of receiving questions or queries and providing answers in response. The knowledge system 238 may be included as part of the contact center system 200 or operated remotely by a third party. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials. As an example, the knowledge system 238 may be embodied as IBM Watson or a similar system.

The chat server 240 may be configured to conduct, orchestrate, and manage electronic chat communications with customers. In general, the chat server 240 is configured to implement and maintain chat conversations and generate chat transcripts. Such chat communications may be conducted by the chat server 240 in such a way that a customer communicates with automated chatbots, human agents, or both. In exemplary embodiments, the chat server 240 may perform as a chat orchestration server that dispatches chat conversations among the chatbots and available human agents. In such cases, the processing logic of the chat server 240 may be rules driven so to leverage an intelligent workload distribution among available chat resources. The chat server 240 further may implement, manage, and facilitate user interfaces (UIs) associated with the chat feature, including those UIs generated at either the customer device 205 or the agent device 230. The chat server 240 may be configured to transfer chats within a single chat session with a particular customer between automated and human sources such that, for example, a chat session transfers from a chatbot to a human agent or from a human agent to a chatbot. The chat server 240 may also be coupled to the knowledge management server 236 and the knowledge systems 238 for receiving suggestions and answers to queries posed by customers during a chat so that, for example, links to relevant articles can be provided.

The web servers 242 may be included to provide site hosts for a variety of social interaction sites to which customers subscribe, such as Facebook, Twitter, Instagram, etc. Though depicted as part of the contact center system 200, it should be understood that the web servers 242 may be provided by third parties and/or maintained remotely. The web servers 242 may also provide webpages for the enterprise or organization being supported by the contact center system 200. For example, customers may browse the webpages and receive information about the products and services of a particular enterprise. Within such enterprise webpages, mechanisms may be provided for initiating an interaction with the contact center system 200, for example, via web chat, voice, or email. An example of such a mechanism is a widget, which can be deployed on the webpages or websites hosted on the web servers 242. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 244 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 244 may be configured to interact with the routing server 218 for selecting an appropriate agent to handle each of the deferrable activities. Once assigned to a particular agent, the deferrable activity is pushed to that agent so that it appears on the agent device 230 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 230 may include a workbin. As an example, a workbin may be maintained in the buffer memory of the corresponding agent device 230.

The universal contact server (UCS) 246 may be configured to retrieve information stored in the customer database and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 249 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 250 may be configured to provide systems and methods for performing analytics on data received from a plurality of different data sources as functionality described herein may require. In accordance with example embodiments, the analytics module 250 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the technologies described herein to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 250 may have access to the data stored in the storage device 220, including the customer database and agent database. The analytics module 250 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 250 may be configured to retrieve data stored within the storage device 220 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 250 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 250 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers in various embodiments. Further, the terms “interaction” and “communication” are used interchangeably, and generally refer to any real-time and non-real-time interaction that uses any communication channel including, without limitation, telephone calls (PSTN or VOIP calls), emails, vmails, video, chat, screen-sharing, text messages, social media messages, WebRTC calls, etc. Access to and control of the components of the contact system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment. It should be appreciated that each of the devices of the call center system 200 may be embodied as, include, or form a portion of one or more computing devices similar to the computing device 100 described below in reference to FIG. 1.

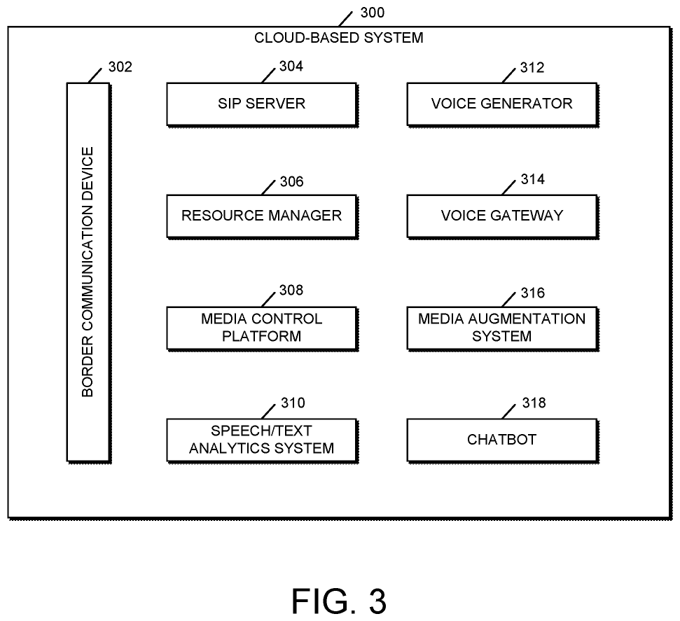

Referring now to FIG. 3, a simplified block diagram of at least one embodiment of a cloud-based system 300 is shown. The illustrative cloud-based system 300 includes a border communication device 302, a SIP server 304, a resource manager 306, a media control platform 308, a speech/text analytics system 310, a voice generator 312, a voice gateway 314, a media augmentation system 316, and a chatbot 318. Although only one border communication device 302, one SIP server 304, one resource manager 306, one media control platform 308, one speech/text analytics system 310, one voice generator 312, one voice gateway 314, one media augmentation system 316, and one chatbot 318 are shown in the illustrative embodiment of FIG. 3, the cloud-based system 300 may include multiple border communication devices 302, SIP servers 304, resource managers 306, media control platforms 308, speech/text analytics systems 310, voice generators 312, voice gateways 314, media augmentation systems 316, and chatbots 318 in other embodiments. For example, in some embodiments, multiple chatbots 318 may be used to communicate regarding different subject matters handled by the same cloud-based system 300. Further, in some embodiments, one or more of the components described herein may be excluded from the system 300, one or more of the components described as being independent may form a portion of another component, and/or one or more of the component described as forming a portion of another component may be independent.

The border communication device 302 may be embodied as any one or more types of devices/systems that are capable of performing the functions described herein. For example, in some embodiments, the border communication device 302 may be configured to control signaling and media streams involved in setting up, conducting, and tearing down voice conversations and other media communications between, for example, an end user and contact center system. In some embodiments, the border communication device 302 may be a session border controller (SBC) controlling the signaling and media exchanged during a media session (also referred to as a “call,” “telephony call,” or “communication session”) between the end user and contact center system. In some embodiments, the signaling exchanged during a media session may include SIP, H.323, Media Gateway Control Protocol (MGCP), and/or any other voice-over IP (VOIP) call signaling protocols. The media exchanged during a media session may include media streams that carry the call's audio, video, or other data along with information of call statistics and quality.

In some embodiments, the border communication device 302 may operate according to a standard SIP back-to-back user agent (B2BUA) configuration. In this regard, the border communication device 302 may be inserted in the signaling and media paths established between a calling and called parties in a VoIP call. In some embodiments, it should be understood that other intermediary software and/or hardware devices may be invoked in establishing the signaling and/or media paths between the calling and called parties.

In some embodiments, the border communication device 302 may exert control over signaling (e.g., SIP messages) and media streams (e.g., RTP data) routed to and from a contact center system (e.g., the contact center system 200) and other devices (e.g., a customer/client device such as the customer device 205, the cloud-based system 300, and/or other devices) that traverse the network (e.g., the network 210). In this regard, the border communication device 302 may be coupled to trunks that carry signals and media for calls to and from the user device over the network, and to trunks that carry signals and media to and from the contact center system over the network.

The SIP server 304 may be embodied as any one or more types of devices/systems that are capable of performing the functions described herein. For example, in some embodiments, the SIP server 304 may act as a SIP B2UBA and may control the flow of SIP requests and responses between SIP endpoints. Any other controller configured to set up and tear down VOIP communication sessions may be contemplated in addition to or in lieu of the SIP server 304 in other embodiments. The SIP server 304 may be a separate logical component or may be combined with the resource manager 306. In some embodiments, the SIP server 304 may be hosted at a contact center system (e.g., the contact center system 200). Although a SIP server 304 is used in the illustrative embodiment, another call server configured with another VoIP protocol may be used in addition to or in lieu of SIP, such as, for example, H.232 protocol, Media Gateway Control Protocol, Skype protocol, and/or other suitable technologies in other embodiments.

The resource manager 306 may be embodied as any one or more types of devices/systems that are capable of performing the functions described herein. In the illustrative embodiment, the resource manager 306 may be configured to allocate and monitor a pool of media control platforms for providing load balancing and high availability for each resource type. In some embodiments, the resource manager 306 may monitor and may select a media control platform 308 from a cluster of available platforms. The selection of the media control platform 308 may be dynamic, for example, based on identification of a location of a calling end user, type of media services to be rendered, detected quality of a current media service, and/or other factors.

In some embodiments, the resource manager 306 may be configured to process requests for media services, and interact with, for example, a configuration server having a configuration database, to determine an interactive voice response (IVR) profile, voice application (e.g. Voice Extensible Markup Language (Voice XML) application), announcement, and conference application, resource, and service profile that can deliver the service, such as, for example, a media control platform. According to some embodiments, the resource manager may provide hierarchical multi-tenant configurations for service providers, enabling them to apportion a select number of resources for each tenant.

In some embodiments, the resource manager 306 may be configured to act as a SIP proxy, a SIP registrar, and/or a SIP notifier. In this regard, the resource manager 306 may act as a proxy for SIP traffic between two SIP components. As a SIP registrar, the resource manager 306 may accept registration of various resources via, for example, SIP REGISTER messages. In this manner, the cloud-based system 300 may support transparent relocation of call-processing components. In some embodiments, components such as the media control platform 308 do not register with the resource manager 306 at startup. The resource manager 306 may detect instances of the media control platform 308 through configuration information retrieved from the configuration database. If the media control platform 308 has been configured for monitoring, the resource manager 306 may monitor resource health by using, for example, SIP OPTIONS messages. In some embodiments, to determine whether the resources in the group are alive, the resource manager 306 may periodically send SIP OPTIONS messages to each media control platform 308 resource in the group. If the resource manager 306 receives an OK response, the resources are considered alive. It should be appreciated that the resource manager 306 may be configured to perform other various functions, which have been omitted for brevity of the description. The resource manager 306 and the media control platform 308 may collectively be referred to as a media controller.

In some embodiments, the resource manager 306 may act as a SIP notifier by accepting, for example, SIP SUBSCRIBE requests from the SIP server 304 and maintaining multiple independent subscriptions for the same or different SIP devices. The subscription notices are targeted for the tenants that are managed by the resource manager 306. In this role, the resource manager 306 may periodically generate SIP NOTIFY requests to subscribers (or tenants) about port usage and the number of available ports. The resource manager 306 may support multi-tenancy by sending notifications that contain the tenant name and the current status (in- or out-of-service) of the media control platform 308 that is associated with the tenant, as well as current capacity for the tenant.

The media control platform 308 may be embodied as any service or system capable of providing media services and otherwise performing the functions described herein. For example, in some embodiments, the media control platform 308 may be configured to provide call and media services upon request from a service user. Such services may include, without limitation, initiating outbound calls, playing music or providing other media while a call is placed on hold, call recording, conferencing, call progress detection, playing audio/video prompts during a customer self-service session, and/or other call and media services. One or more of the services may be defined by voice applications (e.g. VoiceXML applications) that are executed as part of the process of establishing a media session between the media control platform 308 and the end user.

The speech/text analytics system (STAS) 310 may be embodied as any service or system capable of providing various speech analytics and text processing functionalities (e.g., text-to-speech) as will be understood by a person of skill in the art and otherwise performing the functions described herein. The speech/text analytics system 310 may perform automatic speech and/or text recognition and grammar matching for end user communications sessions that are handled by the cloud-based system 300. The speech/text analytics system 310 may include one or more processors and instructions stored in machine-readable media that are executed by the processors to perform various operations. In some embodiments, the machine-readable media may include non-transitory storage media, such as hard disks and hardware memory systems.

The voice generator 312 may be embodied as any service or system capable of generating a voice communication and otherwise performing the functions described herein. In some embodiments, the voice generator 312 may generate the voice communication based on a particular voice signature.

The voice gateway 314 may be embodied as any service or system capable of performing the functions described herein. In the illustrative embodiment, the voice gateway 314 receives end user calls from or places calls to voice communications devices, such as an end user device, and responds to the calls in accordance with a voice program that corresponds to a communication routing configuration of the contact center system. In some embodiments, the voice program may include a voice avatar. The voice program may be accessed from local memory within the voice gateway 314 or from other storage media in the cloud-based system 300. In some embodiments, the voice gateway 314 may process voice programs that are script-based voice applications. The voice program, therefore, may be a script written in a scripting language, such as voice extensible markup language (VoiceXML) or speech application language tags (SALT).

The media augmentation system 316 may be embodied as any service or system capable of specifying how the portions of the cloud-based system 300 (e.g., one or more of the border communications device 302, the SIP server 304, the resource manager 306, the media control platform 308, the speech/text analytics system 310, the voice generator 312, the voice gateway 314, the media augmentation system 316, the chatbot 318, and/or one or more portions thereof) interact with each other and otherwise performing the functions described herein. In some embodiments, the media augmentation system 316 may be embodied as or include an application program interface (API). In some embodiments, the media augmentation system 316 enables integration of differing parameters and/or protocols that are used with various planned application and media types utilized within the cloud-based system 300.

The chatbot 318 may be embodied as any automated service or system capable of using automation to engage with end users and otherwise performing the functions described herein. For example, in some embodiments, the chatbot 318 may operate, for example, as an executable program that can be launched according to demand for the particular chatbot. In some embodiments, the chatbot 318 simulates and processes human conversation (either written or spoken), allowing humans to interact with digital devices as if the humans were communicating with another human. In some embodiments, the chatbot 318 may be as simple as rudimentary programs that answer a simple query with a single-line response, or as sophisticated as digital assistants that learn and evolve to deliver increasing levels of personalization as they gather and process information. In some embodiments, the chatbot 318 includes and/or leverages artificial intelligence, adaptive learning, bots, cognitive computing, and/or other automation technologies. Chatbot 318 may also be referred to herein as one or more chat robots, AI chatbots, automated chat robot, chatterbots, dialog systems, conversational agents, automated chat resources, and/or bots.

A benefit of utilizing automated chat robots for engaging in chat conversations with end users may be that it helps contact centers to more efficiently use valuable and costly resources like human resources, while maintaining end user satisfaction. For example, chat robots may be invoked to initially handle chat conversations without a human end user knowing that it is conversing with a robot. The chat conversation may be escalated to a human resource if and when appropriate. Thus, human resources need not be unnecessarily tied up in handling simple requests and may instead be more effectively used to handle more complex requests or to monitor the progress of many different automated communications at the same time.

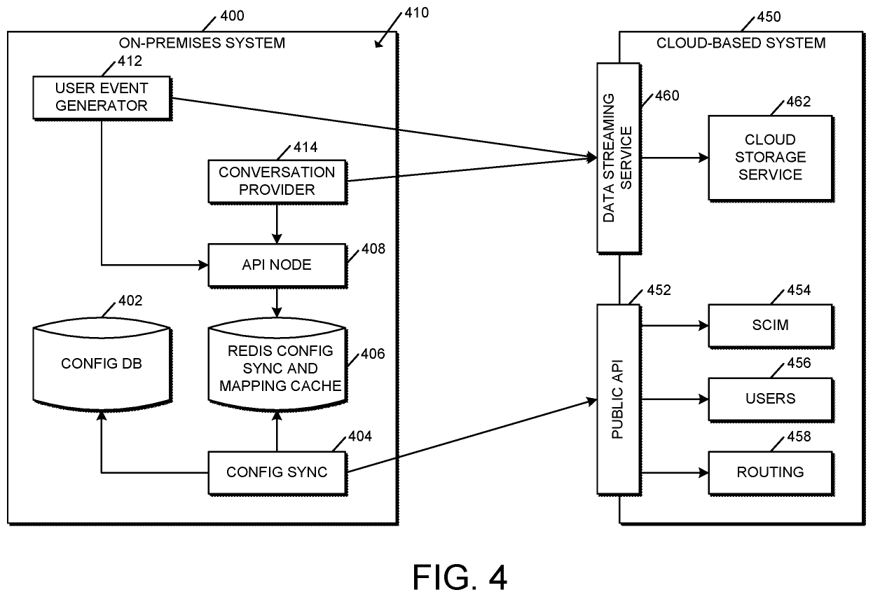

Referring now to FIGS. 4-6, in the illustrative embodiment, an on-premises contact center system 400 is integrated with a cloud-based contact center system 450 via a connector 410. Whether or not the subsequent reference in FIGS. 4-6 includes the corresponding numerical identifiers used in the figures previously described, it should be understood that the reference incorporates the example described in the previous figures and, unless otherwise specifically limited, may be implemented in accordance with either those examples or other technology capable of fulfilling the desired functionality, as would be understood by one of ordinary skill in the art. Thus, for example, subsequent mention of a “contact center system” (e.g., the contact center system 400 and/or the contact center system 450) should be understood as referring to the exemplary “contact center system 200” of FIG. 2 and/or other technologies for implementing a contact center system, at least in some embodiments. As another example, subsequent mention of a “cloud-based contact center system” (e.g., the cloud-based contact center system 450) should be understood as referring to the exemplary “cloud-based system 300” of FIG. 3 and/or other technologies for implementing a cloud-based contact center system, at least in some embodiments.

It should be appreciated that in some embodiments, the on-premises contact center system 400 and the cloud-based contact center system 450 employ different logic and/or different protocols to process event (e.g., call event) data and/or resource data (e.g., user and/or agent data) and provide various functionalities. The connector 410 of the present disclosure enables interoperability between the on-premises system 400 and the cloud-based system 450 and integrates the on-premises system 400 with the cloud-based system 450. Integration of the on-premises contact center system 400 with the cloud-based contact center system 450 via the connector 410 enables an on-premises customer to utilize various tools, suites, services, platforms, or the like in the environment established by the cloud-based contact center system 450. In one example, such integration enables the on-premises customer to utilize a workforce engagement management (WEM) service 570 providing various functionalities associated with the cloud-based system 450, such as resource management, employee performance, and quality assurance and compliance functionalities, for instance. Furthermore, although the integration achieved through use of the connector 410 allows the on-premises customer to utilize the WEM service 570 established in the outside environment of the cloud-based system 450, the on-premises customer is permitted to use various tools, suites, services, platforms, or the like in the customer's local computing environment independent of utilizing the WEM service 570 from the external environment.

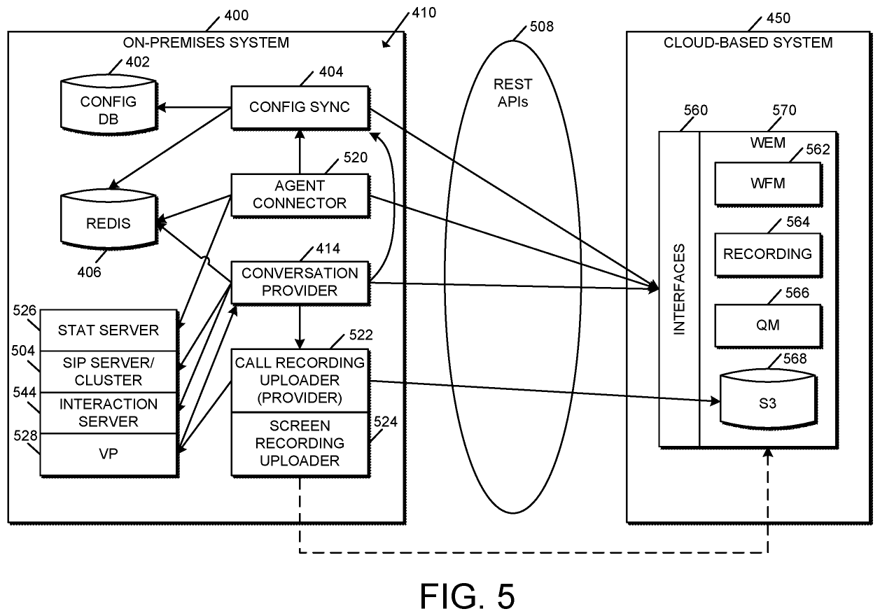

As depicted in FIGS. 4 and 5, the illustrative on-premises contact center system 400 includes a configuration database 402, a configuration synchronization (sync) module 404, a data store 406, an API node 408, an event generator module 412, a conversation provider module 414, an SIP server 504, an agent sync module 520, a call recording module 522, a screen recording module 524, a statistics server 526, a voice platform 528, and an interaction server 544. Although only one configuration database 402, one configuration sync module 404, one data store 406, one API node 408, one event generator module 412, one conversation provider module 414, one SIP server 504, one agent sync module 520, one call recording module 522, one screen recording module 524, one statistics server 526, one voice platform 528, and one interaction server 544 are shown in the illustrative embodiment of FIGS. 4 and 5, in other embodiments, the on-premises contact center system 400 may include multiple configuration databases 402, configuration sync modules 404, data stores 406, API nodes 408, event generator modules 412, conversation provider modules 414, SIP servers 504, agent sync modules 520, call recording modules 522, screen recording modules 524, statistics servers 526, voice platforms 528, and interaction servers 544. In some embodiments, the same cloud-based contact center system 450 may be used to process data from multiple on-premises contact center systems 400. In some embodiments, one or more of the systems, services, and/or components described herein may be excluded from the on-premises contact center system 400, one or more of the systems, services, and/or components described as being independent may form a portion of another system, service, and/or component, and/or one or more features of the systems, services, and/or components may be independent.

Although the on-premises contact center system 400 is described herein as a system local to the customer's computing environment (i.e., on-premises), it should be appreciated that a portion of the on-premises system 400 may be remote relative to the customer's computing environment, at least in some embodiments. For example, in some embodiments, the on-premises system 400 may be embodied as a “closed cloud” system deployed for a particular customer. Likewise, although the cloud-based system 450 is described herein as a cloud-based computing system, the cloud system 450 may include one or more devices/systems positioned outside of a cloud computing environment, at least in some embodiments.

In the illustrative embodiment, the connector 410 includes, but is not limited to, the configuration sync module 404, the data store 406, the conversation provider module 414, the agent sync module 520, the call recording module 522, and the screen recording module 524. The components 404, 406, 414, 520, 522, 524 are communicatively coupled to one another and/or share a common data repository in the data store 406, at least in some embodiments. The components 404, 406, 414, 520, 522, 524 are configured for cooperation with one another to achieve the functionalities of the connector 410 described herein. It should be appreciated that in the illustrative embodiment, the functionalities achieved by the connector 410 are implemented in the local, on-premises environment established by the on-premises contact center system 400.

A number of components of the illustrative on-premises contact center system 400 are adapted for interaction with one or more of the components 404, 406, 414, 520, 522, 524 of the connector 410. Those components include, but are not limited to, the configuration database 402, the SIP server 504, the statistics server 526, the voice platform 528, and the interaction server 544. In at least some embodiments, the components 402, 504, 526, 528, 544 are provided independently from the connector 410 such that the components 402, 504, 526, 528, 544 do not define, or form a portion of, the connector 410. In other embodiments, the components 402, 504, 526, 528, 544 may at least partially define or at least partially form a portion of the connector 410.

The configuration database 402 may include, or otherwise be embodied as, any device or collection of devices capable of storing data relevant to the functioning of the on-premises contact center system 400. In some embodiments, the configuration database 402 may include one or more storage devices, such as storage device(s) 220, for example. In the illustrative embodiment, the configuration database 402 is included in a configuration server of the on-premises system 400.

In some embodiments, the configuration server includes, or is otherwise embodied as, any computing device, server, service, or module or collection of computing devices, servers, services, or modules capable of storing event and/or resource data pertaining to the functioning of the on-premises system 400. Data stored by the configuration server and/or the configuration database 402 may include confirmation details associated with a particular call event and/or resource information associated with a contact center agent. Such data may include, but is not limited to, user/customer information, skills and language information relevant to automatic call distribution (ACD) protocols, divisions, queues, membership to queues, wrap-up codes, primary statuses, and secondary statuses. In some embodiments, the configuration server may employ customer TCP-based protocols to provide call event and/or resource information.

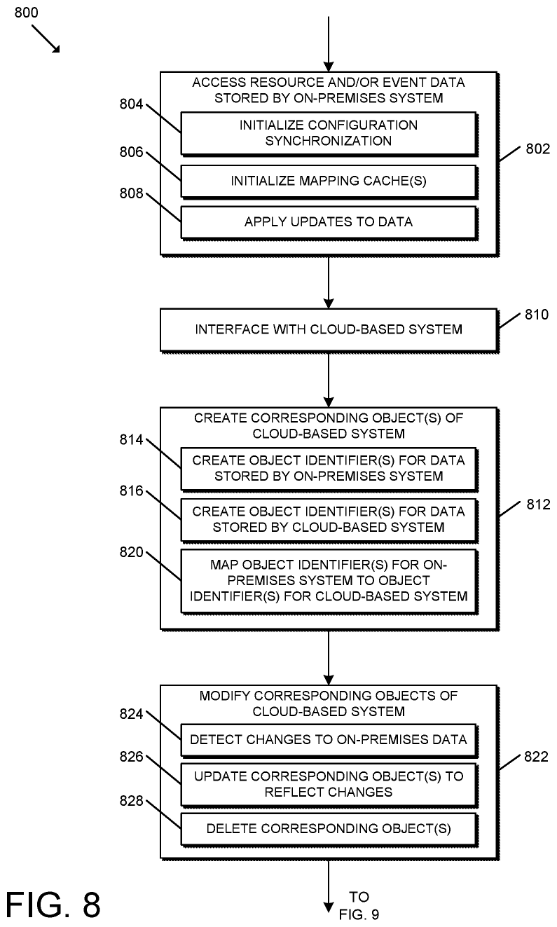

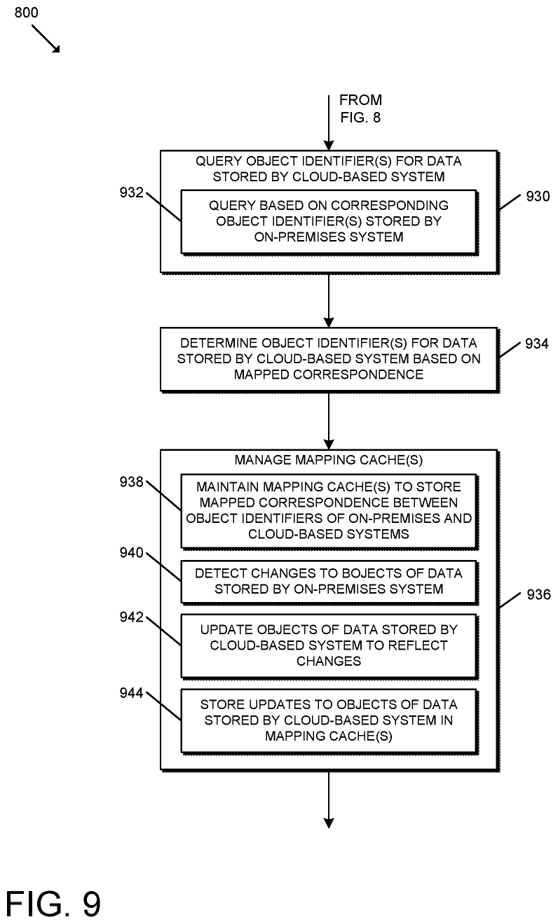

The illustrative configuration sync module 404 includes, or is otherwise embodied as, any computing device, server, service, or module or collection of computing devices, servers, services or modules capable of synchronizing data between the on-premises contact center system 400 and the cloud-based contact center system 450, as discussed below in greater detail with reference to FIGS. 8 and 9. As such, the configuration sync module 404 may be said to provide at least one point of integration or integration node within the connector 410 to enable data synchronization between the on-premises system 400 and the cloud-based system 450 using the connector 410. The configuration sync module 404 is communicatively coupled to the configuration server to access (e.g., direct, read-only access) data stored in the configuration database 402, such as transaction data and/or object data, for example. Additionally, the configuration sync module 404 is communicatively coupled to at least one public application programming interface (API) 452 of the cloud-based system 450 and to various APIs 454, 456, 458 of the cloud-based system 450.

As will be apparent from the discussion of FIGS. 8 and 9 provided below, the configuration sync module 404 provides several functionalities to synchronize data between the on-premises system 400 and the cloud-based system 450 in use of the connector 410. In one aspect, the configuration sync module 404 is configured to read event tables and/or object tables stored in the configuration database 402 to initialize a data synchronization operation, to initialize at least one mapping cache of the data store 406 in preparation for data storage, and to apply subsequent changes or updates (e.g., changes or updates subsequent to initiation of the synchronization operation) to data stored in the mapping cache(s). In another aspect, the configuration sync module 404 is configured to map one or more object identifiers (i.e., object IDs) associated with object data stored by the on-premises system 400 to one or more object IDs associated with object data stored by the cloud-based system 450 to establish a mapped correspondence (e.g., a mapped correspondence table) between the object data stored by the on-premises system 400 and the cloud-based system 450. At least in some embodiments, to develop the mapped correspondence, the configuration sync module 404 interfaces with the one or more APIs (e.g., the APIs 452, 454, 456, 458) of the cloud-based system 450 to create and/or modify (e.g., update or delete) objects of data stored by the system 450 that correspond to objects of data stored by the system 400. Additionally, in some embodiments, the configuration sync module 404 updates the mapped correspondence, as well as corresponding objects of data stored by the system 450, based on updates or changes to objects of data stored by the system 400.

In some embodiments, the configuration sync module 404 listens to the configuration server using a custom protocol. During initialization, the configuration sync module 404 reads data from the configuration server and synchronizes data between the on-premises system 400 and the cloud-based system 450 using one or more APIs (e.g., the APIs 452, 454, 456, 458). The configuration sync module 404 keeps listening to the configuration server for any changes in the configuration of the objects and synchronizes the changes between the on-premises system 400 and the cloud-based system 450 using the API(s). This protocol provides a one-way synchronization of data from the on-premises system 400 to the cloud-based system 450. The configuration sync module 404 maintains a mapping of identifiers between objects stored by the on-premises system 400 and objects stored by the cloud-based system 450 using a set of rest APIs 508. Additionally, the configuration sync module 404 provides the API node 408 to permit queries of object identifiers for objects stored by the cloud-based system 450 based on object identifiers for objects stored by the on-premises system 400. In one example, an integration component on the on-premises system 400 may need to invoke an API to call the cloud-based system 450, and one or more parameters in the API call may be an object identifier for an object that was synchronized from the on-premises system 400. The integration component may need to map object identifier(s) known from the on-premises system 400 to object identifier(s) for data stored by the cloud-based system 450.

In some embodiments, the mapped correspondence established by the configuration sync module 404 defines a resource mapping according to Table 1 shown below. Resources and/or objects associated with the on-premises system 400 are identified in the column on the left, whereas resources and/or objects associated with the cloud-based system 450 are identified in the column on the right.

TABLE 1

| | Cloud-based |
|---|---|
| On-premises object/resource | object/resource |
| Persons (agents, supervisors, admins, users), | User |
| User Roles/Permissions | |
| Data comes from the configuration | |
| server | |
| Skill, Skill Association with User | Skill |
| Data comes from the configuration | |
| server | |
| Sync performed every time a skill | |
| changes on an agent | |
| Queues, User to Queue Association | Queue |
| Data comes from the configuration | |
| server and the switch 212 → DN | |
| object of type (ACD Queue, Routing | |
| Queue, Virtual Queue, Routing Point) | |
| Dynamically associated at the | |
| designer/routing strategy time. Not | |
| static. | |
| Business Attribute (Wrap-up code/disposition | Wrap-Up Code |
| code) | |
| Data comes from the configuration | |
| server and the BusinessAttribute | |
| Values object | |
| Anytime a new disposition code is | |
| added/removed, then the similar action | |
| must be done for all the queues with | |
| the corresponding Cloud Wrap-up | |
| code using the sync logic above the | |
| queue | |

The data store 406 may include, or otherwise be embodied as, any device or collection of devices capable of storing data to facilitate data synchronization between the on-premises system 400 and the cloud-based system 450. The data store 406 is communicatively coupled to the configuration sync module 404. The data store 406 may include an open-source, in-memory data store which provides fast access to a shared cache with persistent storage and supports a cluster of API nodes. In the illustrative embodiment, the data store 406 includes, or is otherwise embodied as, redis. In any case, the mapped correspondence established using the configuration sync module 404 as discussed above is maintained by the data store 406 in at least one mapping cache implemented therein. The mapping cache(s) may maintain all data attributes established during data synchronization so that the configuration sync module 404 can determine if an object stored by the cloud-based system 450 requires an update, at least in some embodiments.

The API node 408 may include, or otherwise be embodied as, any toolkit, suite, or service or collection of toolkits, suites, or services capable of supporting HTTP queries for data (e.g., object identifier(s)) stored by the cloud-based system 450. The API node 408 is communicatively coupled to the data store 406, the event generator module 412, and the conversation provider module 414. Using at least one object identifier for data stored by the on-premises system 400 as a keyword, queries supported by the API node 408 may return the object identifier for the corresponding object stored by the cloud-based system 400, as discussed below with reference to FIG. 9. In some embodiments, the API node 408 and the configuration sync module 404 may be different components of the same microservice with different scaling and availability capabilities.

The event generator module 412 may be embodied as any computing device, server, service, or system or collection of computing devices, servers, services, or systems capable of generating a user event (e.g., a call or chat initiated by the user) that may be communicated to the API node 408 and/or a data streaming service 460 of the cloud-based system 450. The event generator module 412 is communicatively coupled to the API node 408 and the data streaming service 460.

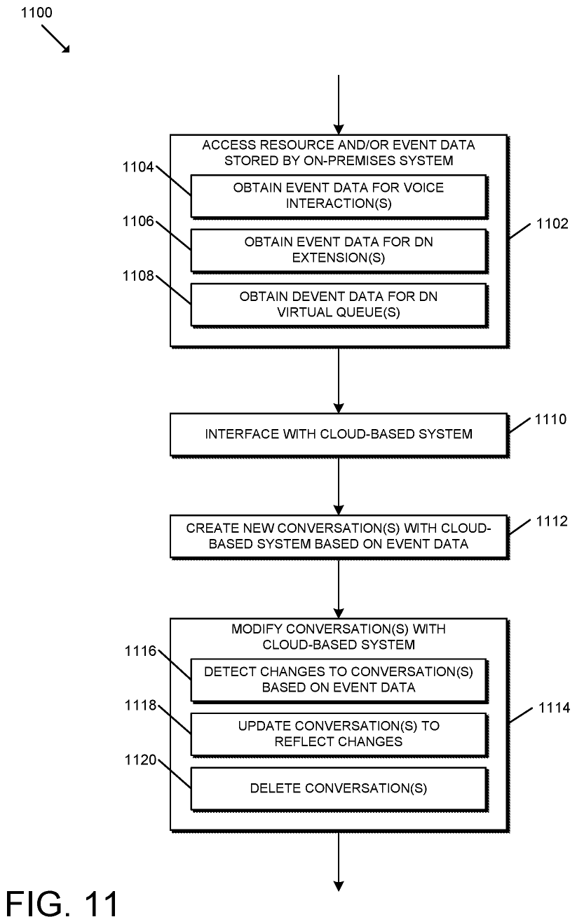

The conversation provider module 414 may be embodied as any computing device, server, service, or system or collection of computing devices, servers, services, or systems capable of synchronizing data between the on-premises contact center system 400 and the cloud-based contact center system 450, as discussed below in greater detail with reference to FIG. 11. As such, the conversation provider module 414 may be said to provide at least one point of integration or integration node within the connector 410 to enable data synchronization between the on-premises system 400 and the cloud-based system 450 using the connector 410. The conversation provider module 414 is communicatively coupled to the configuration sync module 404, the data store 406, the API node 408, the data streaming service 460, the SIP server 504, the voice platform 528, and the interaction server 544.

The conversation provider module 414 is configured to synchronize resource data indicative of a voice interaction (e.g., a voice call) to be routed to a contact center agent between the on-premises system 400 and the cloud-based system 450. To do so, at least in some embodiments, the conversation provider module 414 is configured to monitor the on-premises system 400 for customer voice interactions and create conversations about the customer voice interactions in the cloud-based system 450. In one example, the conversation provider module 414 communicates with the SIP server 504 and listens (e.g., subscribes for a subset of TLibrary and call monitoring events) for any new call and/or for updates or changes in the state of an existing call. In that example, as soon as the conversation provider module 414 receives the information about the call, the conversation provider module 414 creates a new interaction in the cloud-based system 450 or updates the existing interaction in the cloud-based system 450 with the change of state information. In any case, the conversation provider module 414 is configured to process data corresponding to one or more of the following events to build a call representation compatible with the cloud-based system 450: monitored voice interactions, one or more Distinguished Name (DN) extensions, and one or more DN virtual queues.

The SIP server 504 may be embodied as any one or more types of devices/systems that are capable of performing the functions described herein. In some embodiments, the SIP server 504 of the on-premises system 400 may be substantially similar and/or substantially identical to the SIP server 304 described above with reference to the cloud-based system 300. Additionally, in some embodiments, the SIP server 504 may act as a SIP B2UBA and may control the flow of SIP requests and responses between SIP endpoints. In other embodiments, any other controller configured to set up and tear down VoIP communication sessions may be contemplated in addition to or in lieu of the SIP server 504. Although a SIP server 504 is used in the illustrative embodiment, another call server configured with another VoIP protocol may be used in addition to or in lieu of SIP, such as, for example, H.232 protocol, Media Gateway Control Protocol, Skype protocol, and/or other suitable technologies in other embodiments.

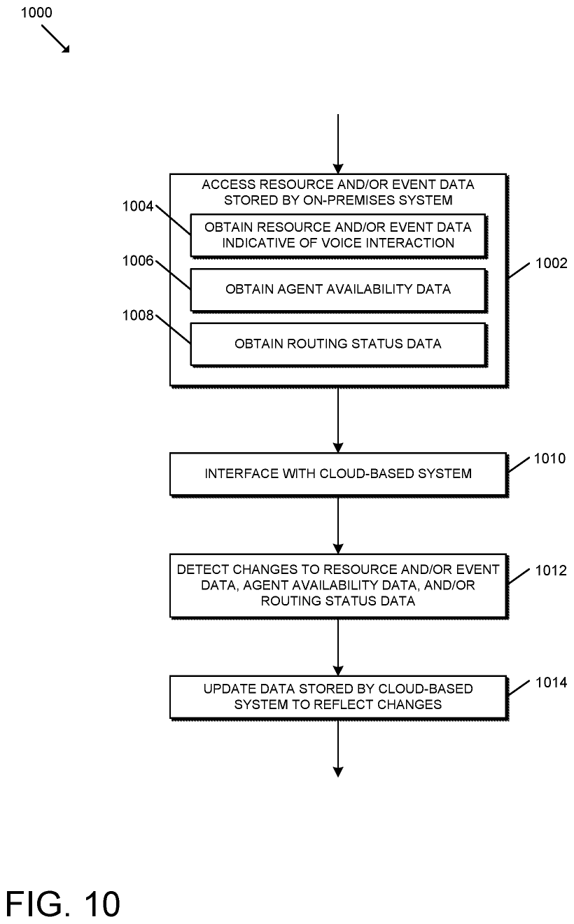

The agent sync module 520 may be embodied as any computing device, server, service, or system or collection of computing devices, servers, services, or systems capable of synchronizing data between the on-premises contact center system 400 and the cloud-based contact center system 450, as discussed below in greater detail with reference to FIG. 10. As such, the agent sync module 520 may be said to provide at least one point of integration or integration node within the connector 410 to enable data synchronization between the on-premises system 400 and the cloud-based system 450 using the connector 410. The agent sync module 520 is communicatively coupled to the configuration sync module 404, the data store 406, and the statistics server 526.

The agent sync module 520 is configured to synchronize resource data indicative of a voice interaction (e.g., a voice call) to be routed to a contact center agent, agent availability data for the contact center agent, and routing status data for the contact center agent between the on-premises system 400 and the cloud-based system 450. To do so, at least in some embodiments, the agent sync module 520 continuously synchronizes resource data regarding the contact center agent's presence (e.g., whether the agent is available) and routing status (e.g., the current work mode for the agent) between the on-premises system 400 and the cloud-based system 450 in real-time or near real-time. As such, at least in some embodiments, the agent sync module 520 enables a contact center agent to switch between multiple platforms or services (e.g., the on-premises system 400, a Cisco platform, and an Avaya platform) while nonetheless having a presence detectable by the cloud-based system 450. In the illustrative embodiment, the agent sync module 520 is configured to support voice agents only, whereas digital and blended agents are not supported. Of course, in other embodiments, the agent sync module 520 may be configured to support multiple agents, such as multiple voice agents, multiple digital agents, and/or multiple blended agents, for instance.

In some embodiments, to synchronize resource data between the on-premises system 400 and the cloud-based system 450, the agent sync module 520 is configured to listen to the statistics server 526 for changes or updates to a contact center agent's status of an agent associated with the on-premises system 400. When the agent sync module 520 detects changes in agent status, the agent sync module 520 is configured to apply the agent status updates to resource data stored by the cloud-based system 450 in real-time or near real-time. Table 2 shown below indicates agent availability and/or routing status data for the on-premises system 400 in the column on the left and agent availability and/or routing status data for the cloud-based system 450 in the column on the right.

TABLE 2

| On-premises agent data | Cloud-Based agent data |
|---|---|
| Ready | On queue |
| Not ready | Busy |
| Logged off | Logged off |

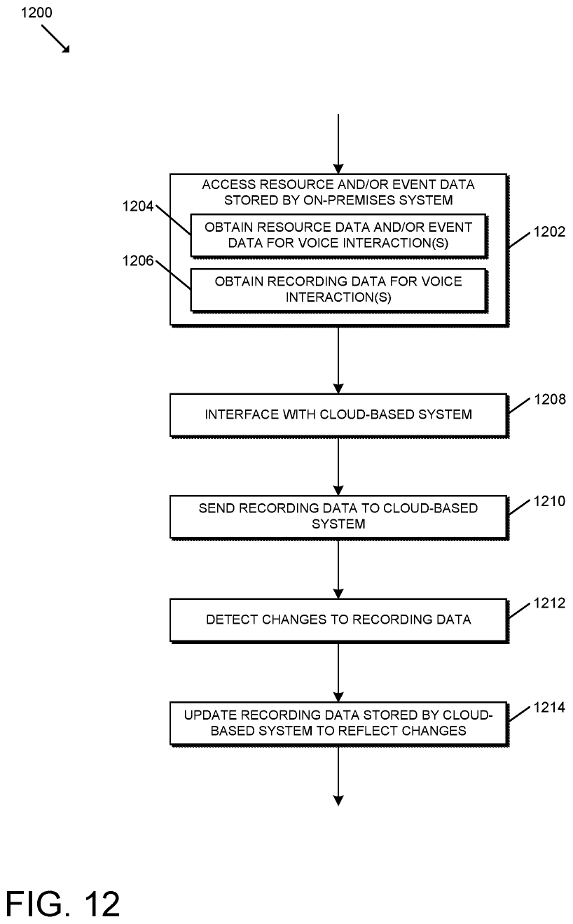

The call recording module 522 may be embodied as any computing device, server, service, or system or collection of computing devices, servers, services, or systems capable of synchronizing data between the on-premises contact center system 400 and the cloud-based contact center system 450, as discussed below in greater detail with reference to FIG. 12. As such, the call recording module 522 may be said to provide at least one point of integration or integration node within the connector 410 to enable data synchronization between the on-premises system 400 and the cloud-based system 450 using the connector 410. The call recording module 522 is communicatively coupled to the conversation provider module 414 and the voice platform 528.

The call recording module 522 is configured to synchronize recording data indicative of a recording of a voice interaction between the on-premises system 400 and the cloud-based system 450. To do so, at least in some embodiments, the call recording module 522 is configured to transmit recording data (e.g., metadata) from recording files stored by the on-premises system 400 to the cloud-based system 450 when the voice interaction ends. As such, at least in some embodiments, the call recording module 522 injects the recording data associated with a conversation into the cloud-based system 450 to make use of recording and quality management functionalities provided by the cloud-based system 450.

In some embodiments, the screen recording module 524 is configured to synchronize screen recording data between the on-premises system 400 and the cloud-based system 450. In some embodiments, the screen recording module 524 may be integrated with, or otherwise form a portion of, the call recording module 522. Additionally, in some embodiments, the screen recording module 524 may be omitted from the on-premises system 400.

The statistics server 526 may be configured to record and aggregate data relating to the performance and operational aspects of the on-premises system 400. In some embodiments, the statistics server 526 may be substantially similar or substantially identical to the statistics server 226 discussed above with reference to FIG. 2. Information compiled by the statistics server 526 may be made available to other servers and modules, which then may use the data to produce reports that are used to manage operational aspects of the on-premises system 400 and execute automated actions in accordance with functionality described herein. Such data may relate to the state of contact center resources, e.g., average wait time, abandonment rate, agent occupancy, and others as functionality described herein would require.

The voice platform 528 may be embodied as any computing device, server, service, or system or collection of computing devices, servers, services, or systems capable of unifying web and VoIP telephony networks to enable voice self-service applications, at least in some embodiments. In some embodiments, the voice platform 528 may provide high performance call processing and media services for the development of unique voice applications in customer service, extend self-service in comparison to other Interactive Voice Response (IVR) applications through integration with other communication channels, remove the cost constraints of other IVR applications, and offer flexible deployment options, standards-based development, and improved time-to-market for speech-directed voice applications. The voice platform 528 is communicatively coupled to the conversation provider module 414 and the call recording module 522.

The interaction server 544 may be configured to manage deferrable activities of the on-premises system 400 and the routing thereof to human agents for completion, at least in some embodiments. Additionally, in some embodiments, the interaction server 544 may be substantially similar or substantially identical to the interaction server 244 discussed above with reference to FIG. 2. The interaction server 544 is communicatively coupled to the conversation provider module 414 as indicated above.

As depicted in FIGS. 4 and 5, the illustrative cloud-based contact center system 450 includes the APIs 452, 454, 456, 458, the data streaming service 460, a cloud storage service 462, a plurality of interfaces 560, and the WEM service 570. In the illustrative embodiment, the WEM service 570 includes a workforce management (WFM) service 562, a recording service 564, a quality management service 566, and an object storage service 568. In at least some embodiments, the set of rest APIs 508 and the interfaces 560 cooperate to establish communicative couplings between various components of the on-premises system 400 and the cloud-based system 450, such as between the WEM service 570 and each one of the configuration sync module 404, the conversation provider module 414, the agent sync module 520, and the call recording module 522.

The data streaming service 460 is illustratively communicatively coupled to the cloud storage service 462. In some embodiments, the cloud storage service 462 may include, or otherwise be embodied as, a Bifrost cloud storage service for storing encrypted data. Of course, in other embodiments, the cloud storage device 462 may include, or otherwise be embodied as, another suitable cloud storage service.

In some embodiments, the API 452 is communicatively coupled to each one of the APIs 454, 456, 458. In other embodiments, the API 452 may be integrated with, or otherwise form a portion of, one or more of the APIs 454, 456, 458. The API 454 is configured as, or is otherwise compatible with, a system for cross-domain identity management (SCIM), at least in some embodiments. The API 456 is configured as a user API which allows a user to create, read, update, and delete users from the user's account, at least in some embodiments. The API 458 is configured as a routing API which is adapted to route one or more incoming HTTP requests from the on-premises system 400 to a particular action method/component of the cloud-based system 450, at least in some embodiments.

The WFM service 562, the recording service 564, the quality management service 566, and the object storage service 568 are each configured as distinct services and/or components of the WEM service 570, at least in some embodiments. Integration of the on-premises system 400 with the cloud-based system 450 via the connector 410 permits an on-premises customer or client to utilize the distinct services 562, 564, 566, 568 included in the WEM service 570, at least in some embodiments. In some embodiments, the object storage service 568 includes, or is otherwise embodied as, the Amazon S3 storage service.

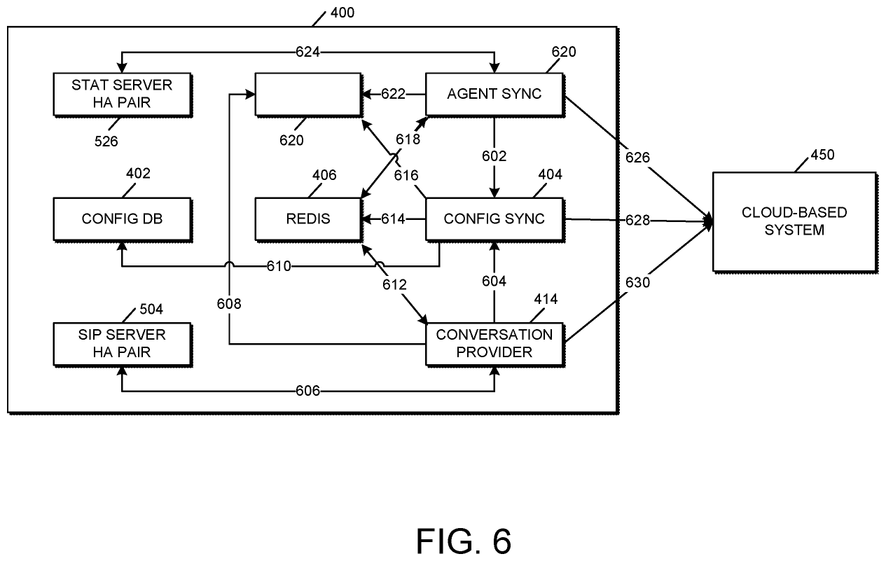

As shown in FIG. 6, a number of communicative couplings, communication links, and/or communication paths are established between various components of the on-premises system 400. Communication link 602 is established between the configuration sync module 404 and the agent sync module 520. Communication link 604 is established between the configuration sync module 404 and the conversation provider module 414. Communication link 606 is established between the conversation provider module 414 and the SIP Server 504. Communication link 608 is established between a component 620 (e.g., a computing device, server, service, or system) and the conversation provider module 414. Communication link 610 is established between the configuration database 402 and the configuration sync module 404. Communication link 612 is established between the data store 406 and the conversation provider module 414. Communication link 614 is established between the data store 406 and the configuration sync module 404. Communication link 616 is established between the component 620 and the configuration sync module 404. Communication link 618 is established between the agent sync module 520 and the data store 406. Communication link 622 is established between the component 620 and the agent sync module 520. Communication link 624 is established between the statistics server 526 and the agent sync module 520.

Communication links 626, 628, 630 are illustratively established between the on-premises contact center system 400 and the cloud-based contact center system 450. Communication link 626 is established between the agent sync module 520 and the cloud-based system 450. Communication link 628 is established between the configuration sync module 404 and the cloud-based system 450. Communication link 630 is established between the conversation provider module 414 and the cloud-based system 450. In some embodiments, the communication links 626, 628, 630 are established between one or more APIs implemented in an environment of the cloud-based system 450 and the agent sync module 520, the configuration sync module 404, and the conversation provider module 414, respectively. Additionally, in some embodiments, the communication links 626, 628, 630 may be established in use of the connector 410, or may be a product of integration of the on-premises system 400 with the cloud-based system 450 using the connector 410.

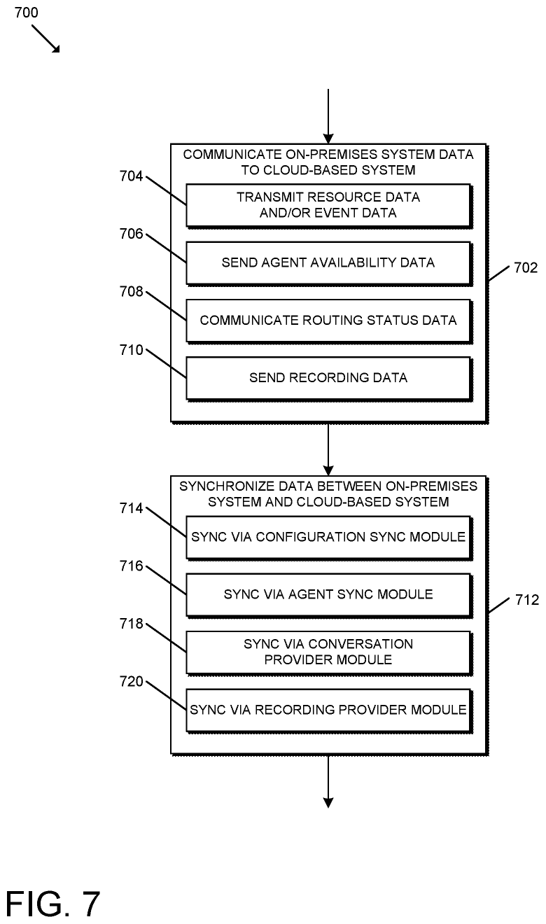

Referring now to FIG. 7, in use, a system or a device may execute a method 700 of integrating an on-premises contact center system (e.g., the on-premises system 400) with a cloud-based contact center system (e.g., the cloud-based system 450) via a connector (e.g., the connector 410). It should be appreciated that, in some embodiments, the system or device may include, or otherwise be embodied as, a connector (e.g., the connector 410), interoperability platform, interoperability service, or interoperability server, which may be incorporated into, define, or otherwise form a portion of, the on-premises system 400. Furthermore, in some embodiments, the system or device may be embodied as, or otherwise include, a suite of tools to assist with the operational monitoring, management, and troubleshooting of various platforms, such as the on-premises system 400 and the cloud-based system 450. Finally, it should be appreciated that the particular blocks of the method 700 are illustrated by way of example, and such blocks may be combined or divided, added or removed, and/or reordered in whole or in part depending on the particular embodiment, unless stated to the contrary.

The illustrative method 700 begins with block 702 in which the system or device communicates data stored by the on-premises system 400 to the cloud-based system 450. It should be appreciated that, in some embodiments, the communication of data in block 702 may include, or occur contemporaneously with, reading data and exchanging data between the on-premises system 400 and the cloud-based system 450 in use of the connector 410. Additionally, in some embodiments, it should be appreciated that communication of data in block 702 may be performed as an initial or prerequisite operation to the data synchronization operations described below. In some embodiments still, communication of data in block 702 may incorporated into one or more synchronization operations as an initializing activity or step thereof.

In the illustrative embodiment, to perform block 702, the system or device performs blocks 704, 706, 708, 710. In block 704, the system or device transmits resource data and/or event data (e.g., for object(s) stored by the on-premises system 400) to the cloud-based system 450. In block 706, the system or device sends agent availability data (e.g., stored by the on-premises system 400) to the cloud-based system 704. In block 708, the system or device communicates routing status data (e.g., stored by the on-premises system 400) to the cloud-based system 450. In block 710, the system or device sends recording data (e.g., stored by the on-premises system 400) to the cloud-based system 450. Although the blocks 704, 706, 708, 710 are depicted individually in FIG. 7, one or more of the blocks may be combined as mentioned above. In one example, blocks 706, 708, and/or 710 may be combined with, or incorporated into, block 704.

In block 712 of the illustrative method 700, the system or device synchronizes data between the on-premises system 400 and the cloud-based system 450. It should be appreciated that data synchronization performed in block 712 may be a product of integration of the on-premises system 400 with the cloud-based system 450 using the connector 410, at least in some embodiments. Additionally, in some embodiments, it should be appreciated that data synchronization may be performed in block 712 as an initial integration operation. In any case, data synchronization includes, for the purposes of the present disclosure, any operation, service, or action to harmonize data storage between the on-premises system 400 and the cloud-based system 450 and maintain consistency between the data stored by the systems 400, 450.

In the illustrative embodiment, to perform block 712, the system or device performs blocks 714, 716, 718, 720. In block 712, the system or device performs data synchronization via the configuration sync module 404, which is described in further detail below with reference to FIGS. 8 and 9. In block 714, the system or device performs data synchronization via the agent sync module 520, which is described in further detail below with reference to FIG. 10. In block 716, the system or device performs data synchronization via the conversation provider module 414, which is described in further detail below with reference to FIG. 11. In block 718, the system or device performs data synchronization via the call recording module 522, which is described in further detail below with reference to FIG. 12. Although the blocks 714, 716, 718, 720 are depicted individually in FIG. 7, one or more of the blocks may be combined as mentioned above.

Although the blocks 702-720 are described in a relatively serial manner, it should be appreciated that various blocks of the method 700 may be performed in parallel, at least in some embodiments.

Referring now to FIGS. 8 and 9, in use, a system or a device may execute a method 800 of synchronizing data between the on-premises contact center system 400 and the cloud-based contact center system 450 via the configuration sync module 404 of the connector. It should be appreciated that, in some embodiments, the system or device may include, or otherwise be embodied as, a connector (e.g., the connector 410), interoperability platform, interoperability service, or interoperability server, which may be incorporated into, define, or otherwise form a portion of, the on-premises system 400. Furthermore, in some embodiments, the system or device may be embodied as, or otherwise include, a suite of tools to assist with the operational monitoring, management, and troubleshooting of various platforms, such as the on-premises system 400 and the cloud-based system 450. Finally, it should be appreciated that the particular blocks of the method 800 are illustrated by way of example, and such blocks may be combined or divided, added or removed, and/or reordered in whole or in part depending on the particular embodiment, unless stated to the contrary.

The illustrative method 800 begins with block 802 in which the system or device accesses resource data and/or event data stored by the on-premises system 400. It should be appreciated that, in some embodiments, resource data and/or event data may be accessed during performance of, or subsequent to performance of, block 702. In any case, to perform block 802, the system or device performs blocks 804, 806, 808. In block 804, the system or device initializes configuration synchronization between the on-premises system 400 (e.g., data stored by the configuration server and/or configuration database 402) and the cloud-based system 450. In some embodiments, in block 804, the system or device reads data from the configuration server to perform initialization in that operation. In block 806, the system or device initializes at least one mapping cache stored on the data store 406 which is configured to store one or more mapped correspondence tables, as discussed below. In block 808, the system or device applies updates to data accessed from the configuration server and/or data stored by the mapping cache(s).

In block 810 of the illustrative method 800, the system or device interfaces with the cloud-based system 450. In some embodiments, the system or device interfaces with the cloud-based system 450 through the interfaces 560, one or more of the rest APIs 508, and/or one or more of the APIs 452, 454, 456, 458. Of course, in other embodiments, the system or device may interface with the cloud-based system 450 through other suitable interfaces, APIs, and/or interoperability platforms.

In block 812 of the illustrative method 800, the system or device (e.g., the configuration sync module 404) creates and/or stores one or more objects of the cloud-based system 450 that correspond to one or more objects of the on-premises system 400. To do so, the system or device performs blocks 814, 816, 820. In block 814, the system or device creates and/or stores at least one object identifier associated with one or more data objects stored by the on-premises system 400. In block 816, the system or device creates and/or stores at least one object identifier associated with one or more data objects stored by the cloud-based system 450. In block 820, the system or device maps the object identifier(s) of the on-premises system 400 to the object identifier(s) of the cloud-based system 450. In some embodiments, block 820 may be performed in one or more iterations to establish the mapped correspondence (e.g., in one or more tables) between objects stored by the on-premises system 400 and objects stored by the cloud-based system 450.

In block 822 of the illustrative method 800, the system or device (e.g., the configuration sync module 404) modifies corresponding objects between the on-premises system 400 and the cloud-based system 450. In the illustrative embodiment, to perform block 822, the system or device performs blocks 824, 826, 828. In block 824, the system or device detects changes to one or more data objects stored by the on-premises system 400. In block 826, the system or device updates the one or more data objects stored by the cloud-based system 450 that correspond to the data objects stored by the on-premises system 400 according to the mapped correspondence to reflect the changes detected in block 824. In block 828, the system or device deletes one or more of the corresponding objects.

In block 930 of the illustrative method 800, the system or device (e.g., the configuration sync module 404) queries at least one object identifier associated with data stored by the cloud-based system 450. In the illustrative embodiment, to perform block 930, the system or device performs block 932. In block 932, the system or device queries at least one object identifier for data stored by the cloud-based system 450 based on the corresponding object identifier(s) of data objects stored by the on-premises system 400. Such correspondence is determined by the mapped correspondence table(s) stored by the data store 406, at least in some embodiments.

In block 934 of the illustrative method 800, the system or device determines the one or more object identifiers queried in block 930 based on the mapped correspondence stored in the at least one mapping cache of the data store 406. In some embodiments, block 934 may be performed by the configuration sync module 404 as mentioned above.

In block 936 of the illustrative method 800, the system or device (e.g., the configuration sync module 404) manages the at least one mapping cache to store the mapped correspondence data and manages updates thereto. To do so, the system or device performs blocks 938, 940, 942, 944. In block 938, the system or device maintains the mapping cache(s) to store the mapped correspondence between data stored by the on-premises system 400 and the cloud-based system 450. In block 940, the system or device detect changes to one or more data objects stored by the on-premises system 400. In block 942, the system or device updates one or more objects (e.g., object identifier(s)) of data stored by the cloud-based system 450 to reflect the changes. In block 944, the system or device stores the updates to the one or more data objects stored by the cloud-based system 450, and any relevant updates to the mapped correspondence tables, in the at least one mapping cache of the data store 406.

Although the blocks 802-944 are described in a relatively serial manner, it should be appreciated that various blocks of the method 800 may be performed in parallel, at least in some embodiments.

Referring now to FIG. 10, in use, a system or a device may execute a method 1000 of synchronizing data between the on-premises contact center system 400 and the cloud-based contact center system 450 via the agent sync module 520 of the connector 410. It should be appreciated that, in some embodiments, the system or device may include, or otherwise be embodied as, a connector (e.g., the connector 410), interoperability platform, interoperability service, or interoperability server, which may be incorporated into, define, or otherwise form a portion of, the on-premises system 400. Furthermore, in some embodiments, the system or device may be embodied as, or otherwise include, a suite of tools to assist with the operational monitoring, management, and troubleshooting of various platforms, such as the on-premises system 400 and the cloud-based system 450. Finally, it should be appreciated that the particular blocks of the method 1000 are illustrated by way of example, and such blocks may be combined or divided, added or removed, and/or reordered in whole or in part depending on the particular embodiment, unless stated to the contrary.

The illustrative method 1000 begins with block 1002 in which the system or device accesses resource data and/or event data stored by the on-premises system 400. To perform block 1002, in the illustrative embodiment, the system or device performs blocks 1004, 1006, 1008. In block 1004, the system or device obtains resource data and/or event data indicative of a voice interaction and/or a call event from the on-premises system 400. In block 1006, the system or device obtains agent availability data for routing of the voice interaction and/or call event to an agent from the on-premises system 400. In block 1008, the system or device obtains routing status data associated with routing the voice interaction and/or call event to the agent from the on-premises system 400. In some embodiments, to perform block 1002, the system or device may obtain data from the statistics server 526 and/or the configuration server of the on-premises system 400.

In block 1010 of the illustrative method 1000, the system or device interfaces with the cloud-based system 450. In some embodiments, the system or device interfaces with the cloud-based system 450 through the interfaces 560, one or more of the rest APIs 508, and/or one or more of the APIs 452, 454, 456, 458. Of course, in other embodiments, the system or device may interface with the cloud-based system 450 through other suitable interfaces, APIs, and/or interoperability platforms.

In block 1012 of the illustrative method 1000, the system or device detects changes to the voice interaction and/or call event data, the agent availability data, and/or the routing status data obtained in block 1002.

In block 1014 of the illustrative method 1000, the system or device updates the data stored by the cloud-based system 450 to reflect the changes detected in block 1012.

Although the blocks 1002-1014 are described in a relatively serial manner, it should be appreciated that various blocks of the method 1000 may be performed in parallel, at least in some embodiments.

Referring now to FIG. 11, in use, a system or a device may execute a method 1100 of synchronizing data between the on-premises contact center system 400 and the cloud-based contact center system 450 via the conversation provider module 414 of the connector 410. It should be appreciated that, in some embodiments, the system or device may include, or otherwise be embodied as, a connector (e.g., the connector 410), interoperability platform, interoperability service, or interoperability server, which may be incorporated into, define, or otherwise form a portion of, the on-premises system 400. Furthermore, in some embodiments, the system or device may be embodied as, or otherwise include, a suite of tools to assist with the operational monitoring, management, and troubleshooting of various platforms, such as the on-premises system 400 and the cloud-based system 450. Finally, it should be appreciated that the particular blocks of the method 1100 are illustrated by way of example, and such blocks may be combined or divided, added or removed, and/or reordered in whole or in part depending on the particular embodiment, unless stated to the contrary.

The illustrative method 1100 begins with block 1102 in which the system or device accesses resource data and/or event data stored by the on-premises system 400. To perform block 1102, in the illustrative embodiment, the system or device performs blocks 1104, 1106, 1108. In block 1104, the system or device obtains resource data and/or event data indicative of voice interaction(s) and/or call event(s) from the on-premises system 400. In block 1106, the system or device obtains event data for DN extensions from the on-premises system 400. In block 1108, the system or device obtains event data for DN virtual queues from the on-premises system 400.

In block 1110 of the illustrative method 1100, the system or device interfaces with the cloud-based system 450. In some embodiments, the system or device interfaces with the cloud-based system 450 through the interfaces 560, one or more of the rest APIs 508, and/or one or more of the APIs 452, 454, 456, 458. Of course, in other embodiments, the system or device may interface with the cloud-based system 450 through other suitable interfaces, APIs, and/or interoperability platforms.

In block 1112 of the illustrative method 1100, the system or device creates one or more new conversations with the cloud-based system 450 in response to the resource data and/or event date obtained in block 1102. In some embodiments, new conversation(s) may be created with the cloud-based system 450 in block 1112 based on data obtained in any one of blocks 1104, 1106, 1108.

In block 1114 of the illustrative method 1100, the system or device modifies the conversation(s) with the cloud-based system 450 created in block 1112. To do so, the system or device performs blocks 1116, 1118, 1120. In block 1116, the system or device detects changes to conversation(s) created in block 1112 based on event data obtained from the on-premises system 400 (e.g., event data obtained in block 1102). In block 1118, the system or device updates the conversation(s) created in block 1112 to reflect the changes. In block 1120, the system or device deletes the conversation(s) created in block 1112.

Although the blocks 1102-1120 are described in a relatively serial manner, it should be appreciated that various blocks of the method 1100 may be performed in parallel, at least in some embodiments.

Referring now to FIG. 12, in use, a system or a device may execute a method 1200 of synchronizing data between the on-premises contact center system 400 and the cloud-based contact center system 450 via the call recording module 522 of the connector 410. It should be appreciated that, in some embodiments, the system or device may include, or otherwise be embodied as, a connector (e.g., the connector 410), interoperability platform, interoperability service, or interoperability server, which may be incorporated into, define, or otherwise form a portion of, the on-premises system 400. Furthermore, in some embodiments, the system or device may be embodied as, or otherwise include, a suite of tools to assist with the operational monitoring, management, and troubleshooting of various platforms, such as the on-premises system 400 and the cloud-based system 450. Finally, it should be appreciated that the particular blocks of the method 1200 are illustrated by way of example, and such blocks may be combined or divided, added or removed, and/or reordered in whole or in part depending on the particular embodiment, unless stated to the contrary.

The illustrative method 1200 begins with block 1202 in which the system or device accesses resource data and/or event data stored by the on-premises system 400. To perform block 1202, in the illustrative embodiment, the system or device performs blocks 1204 and 1206. In block 1204, the system or device obtains resource data and/or event data indicative of voice interaction(s) and/or call event(s) from the on-premises system 400. In block 1206, the system or device obtains recording data for the voice interaction(s) and/or call event(s) identified in block 1204 that is stored by the call recording module 522.

In block 1208 of the illustrative method 1200, the system or device interfaces with the cloud-based system 450. In some embodiments, the system or device interfaces with the cloud-based system 450 through the interfaces 560, one or more of the rest APIs 508, and/or one or more of the APIs 452, 454, 456, 458. Of course, in other embodiments, the system or device may interface with the cloud-based system 450 through other suitable interfaces, APIs, and/or interoperability platforms.

In block 1210 of the illustrative method 1200, the system or device sends recording data for the voice interaction(s) and/or call event(s) identified in block 1204 to the cloud-based system 450.

In block 1212 of the illustrative method 1200, the system or device detects changes to the recording data obtained in block 1202 from the on-premises system 400.

In block 1214 of the illustrative method 1200, the system or device updates the recording data stored by the cloud-based system 450 to reflect the changes from block 1212.

Although the blocks 1202-1214 are described in a relatively serial manner, it should be appreciated that various blocks of the method 1200 may be performed in parallel, at least in some embodiments.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A connector for integrating an on-premises contact center with a cloud-based system contact center, the connector comprising:
at least one processor; and
at least one memory having a plurality of instructions stored therein that, in response to execution by the at least one processor, causes the connector to:
communicate resource data stored by the on-premises contact center to the cloud-based contact center, and
synchronize the resource data between the on-premises contact center and the cloud-based contact center to maintain consistency between the resource data stored by the on-premises contact center and the resource data stored by the cloud-based contact center,
wherein to synchronize the resource data between the on-premises contact center and the cloud-based contact center comprises to:
create at least one first object identifier associated with one or more objects of the resource data stored by the on-premises contact center,
create at least one second object identifier associated with one or more objects of the resource data stored by the cloud-based contact center, and
map the at least one first object identifier to the at least one second object identifier to establish a mapped correspondence between the one or more objects of the resource data stored by the on-premises contact center and the one or more objects of the resource data stored by the cloud-based contact center.

2. The connector of claim 1, wherein to synchronize the resource data between the on-premises contact center and the cloud-based contact center comprises to:
detect changes to the one or more objects of the resource data stored by the on-premises contact center; and
update the one or more objects of the resource data stored by the cloud-based contact center such that the one or more objects of the resource data stored by the cloud-based contact center reflect the changes to the one or more objects of the resource data stored by the on-premises contact center.

3. The connector of claim 2, wherein to update the one or more objects of the resource data stored by the cloud-based contact center comprises to update the one or more objects of the resource data stored by the cloud-based contact center based on the mapped correspondence.

4. The connector of claim 1, wherein to synchronize the resource data between the on-premises contact center and the cloud-based contact center comprises to:
query one object identifier associated with the one or more objects of the resource data stored by the cloud-based contact center,
determine the one object identifier based on another object identifier associated with the one or more objects of the resource data stored by the on-premises contact center that corresponds to the one object identifier according to the mapped correspondence.

5. The connector of claim 4, wherein to synchronize the resource data between the on-premises contact center and the cloud-based contact center comprises to:
maintain at least one cache to store the mapped correspondence between the one object identifier and the another object identifier;
detect changes to the one or more objects of the resource data stored by the on-premises contact center;
update the one or more objects of the resource data stored by the cloud-based contact center such that the one or more objects of the resource data stored by the cloud-based contact center reflect the changes to the one or more objects of the resource data stored by the on-premises contact center; and
store the updates to the one or more objects of the resource data stored by the cloud-based contact center in the at least one cache.

6. The connector of claim 1, wherein to communicate resource data stored by the on-premises contact center to the cloud-based contact center comprises to:
transmit resource data indicative of a voice interaction to be routed to a contact center agent to the cloud-based contact center,
send agent availability data associated with the transmitted resource data to the cloud-based contact center, and
communicate routing status data associated with the transmitted resource data to the cloud-based contact center.

7. The connector of claim 6, wherein to synchronize the resource data between the on-premises contact center and the cloud-based contact center comprises to:
detect changes to the transmitted resource data, the agent availability data, and/or the routing status data, and
update the resource data transmitted to the cloud-based contact center, the agent availability data, and/or the routing status data to reflect the changes.

8. The connector of claim 1, wherein to communicate resource data stored by the on-premises contact center to the cloud-based contact center comprises to transmit resource data indicative of a voice interaction to be routed to a contact center agent to the cloud-based contact center, and
wherein to synchronize the resource data between the on-premises contact center and the cloud-based contact center comprises to detect changes to the transmitted resource data and to update the resource data transmitted to the cloud-based contact center to reflect the changes.

9. The connector of claim 8, wherein the resource data transmitted to the cloud-based contact center comprises at least one of the following:
event data corresponding to a monitored voice interaction,
event data corresponding to one or more distinguished name (DN) extensions, and
event data corresponding to one more distinguished name (DN) virtual queues.

10. The connector of claim 8, wherein to communicate resource data stored by the on-premises contact center to the cloud-based contact center comprises to send recording data indicative of a recording of the voice interaction to the cloud-based contact center, and
wherein to synchronize the resource data between the on-premises contact center and the cloud-based contact center comprises to detect changes in the recording data and to update the recording data sent to the cloud-based contact center to reflect the changes.

11. The connector of claim 1, wherein the connector is implemented in an environment established by the on-premises contact center.

12. A method of integrating an on-premises contact center with a cloud-based contact center, the method comprising:
communicating resource data stored by the on-premises contact center to the cloud-based contact center, and
synchronizing the resource data between the on-premises contact center and the cloud-based contact center to maintain consistency between the resource data stored by the on-premises contact center and the resource data stored by the cloud-based contact center,
wherein synchronizing the resource data between the on-premises contact center and the cloud-based contact center comprises:
creating at least one first object identifier associated with one or more objects of the resource data stored by the on-premises contact center,
creating at least one second object identifier associated with one or more objects of the resource data stored by the cloud-based contact center, and
mapping the at least one first object identifier to the at least one second object identifier to establish a mapped correspondence between the one or more objects of the resource data stored by the on-premises contact center and the one or more objects of the resource data stored by the cloud-based contact center.

13. The method of claim 12, wherein synchronizing the resource data between the on-premises contact center and the cloud-based contact center comprises:
detecting changes to the one or more objects of the resource data stored by the on-premises contact center, and
updating the one or more objects of the resource data stored by the cloud-based contact center such that the one or more objects of the resource data stored by the cloud-based contact center reflect the changes to the one or more objects of the resource data stored by the on-premises contact center, wherein updating the one or more objects of the resource data stored by the cloud-based contact center comprises updating the one or more objects of the resource data stored by the cloud-based contact center based on the mapped correspondence.

14. The method of claim 12, wherein synchronizing the resource data between the on-premises contact center and the cloud-based contact center comprises:
querying one object identifier associated with the one or more objects of the resource data stored by the cloud-based contact center, and
determining the one object identifier based on another object identifier associated with the one or more objects of the resource data stored by the on-premises contact center that corresponds to the one object identifier according to the mapped correspondence.

15. The method of claim 14, wherein synchronizing the resource data between the on-premises contact center and the cloud-based contact center comprises:
maintaining at least one cache to store the mapped correspondence between the one object identifier and the another object identifier,
detecting changes to the one or more objects of the resource data stored by the on-premises contact center,
updating the one or more objects of the resource data stored by the cloud-based contact center such that the one or more objects of the resource data stored by the cloud-based contact center reflect the changes to the one or more objects of the resource data stored by the on-premises contact center, and
storing the updates to the one or more objects of the resource data stored by the cloud-based contact center in the at least one cache.

16. The method of claim 12, wherein communicating resource data stored by the on-premises contact center to the cloud-based contact center comprises:
transmitting resource data indicative of a voice interaction to be routed to a contact center agent to the cloud-based contact center,
sending agent availability data associated with the transmitted resource data to the cloud-based contact center, and
communicating routing status data associated with the transmitted resource data to the cloud-based contact center.

17. The method of claim 16, wherein synchronizing the resource data between the on-premises contact center and the cloud-based contact center comprises:
detecting changes to the transmitted resource data, the agent availability data, and/or the routing status data, and
updating the resource data transmitted to the cloud-based contact center, the agent availability data, and/or the routing status data to reflect the changes.

18. The method of claim 12, wherein:
communicating resource data stored by the on-premises contact center to the cloud-based contact center comprises (i) transmitting resource data indicative of a voice interaction to be routed to a contact center agent to the cloud-based contact center and (ii) sending recording data indicative of a recording of the voice interaction to the cloud-based contact center,
synchronizing the resource data between the on-premises contact center and the cloud-based contact center comprises (i) detecting changes to the transmitted resource data, (ii) detecting changes in the recording data, (iii) updating the resource data transmitted to the cloud-based contact center to reflect the changes in the transmitted resource data, and (iv) updating the recording data sent to the cloud-based contact center to reflect the changes in the recording data.

19. One or more non-transitory machine readable storage media comprising a plurality of instructions stored thereon that, in response to execution by a connector, causes the connector to:
communicate resource data stored by an on-premises contact center to a cloud-based contact center, and
synchronize the resource data between the on-premises contact center and the cloud-based contact center to maintain consistency between the resource data stored by the on-premises contact center and the resource data stored by the cloud-based contact center,
wherein to synchronize the resource data between the on-premises contact center and the cloud-based contact center comprises to:
create at least one first object identifier associated with one or more objects of the resource data stored by the on-premises contact center,
create at least one second object identifier associated with one or more objects of the resource data stored by the cloud-based contact center, and
map the at least one first object identifier to the at least one second object identifier to establish a mapped correspondence between the one or more objects of the resource data stored by the on-premises contact center and the one or more objects of the resource data stored by the cloud-based contact center.

20. The one or more non-transitory machine readable storage media of claim 19, wherein to synchronize the resource data between the on-premises contact center and the cloud-based contact center comprises to:
detect changes to the one or more objects of the resource data stored by the on-premises contact center, and
update the one or more objects of the resource data stored by the cloud-based contact center such that the one or more objects of the resource data stored by the cloud-based contact center reflect the changes to the one or more objects of the resource data stored by the on-premises contact center.
